(19) United States
(12) Patent Application Publication
(10) Pub. No.: US 2016/0093923 A1
(43) Pub. Date: Mar. 31, 2016

(54) INHERENTLY SAFE THERMO-RESPONSIVE GEL ELECTROLYTES FOR ELECTROCHEMICAL DEVICES

(71) Applicants: HongPeng Wang, Sunnyvale, CA (US); Chun-Yi Liang, Taipei (TW)

(72) Inventors: HongPeng Wang, Sunnyvale, CA (US); Chun-Yi Liang, Taipei (TW)

(21) Appl. No.: 14/868,071

(22) Filed: Sep. 28, 2015

Related U.S. Application Data
(60) Provisional application No. 62/056,316, filed on Sep. 26, 2014.

(51) Int. Cl. H01M 10/42; H01M 10/0565

(52) U.S. Cl. CPC H01M 10/4235; H01M 10/0565; H01M 2300/0085

(57) ABSTRACT

Techniques for providing phase change electrolytes that can be used to improve safety of electrochemical devices, such as lithium batteries, are disclosed herein. At normal operation temperature, the phase change electrolyte is capable of switching “on” with high ionic conductivities in a liquid state. When an electrochemical device system (filled with the phase change electrolyte) encounters abnormal high temperature due to overcharge or shorting, the phase change electrolyte inside the device is capable of switching “off” with low ionic conductivities in a gel state and shut down ionic conductive flow to prevent disastrous electrochemical or chemical events, such as thermal runaway and explosion. When temperature of the electrochemical device returns to normal, the phase change material inside the electrochemical device can switch back to “on” with high ionic conductivities in a liquid state, thereby providing electrochemical devices with inherent safety, especially for rechargeable lithium batteries.

### CROSS REFERENCE TO RELATED APPLICATIONS

This application claims the benefit of U.S. Provisional Patent Application No. 62/056,316, titled “Inherently Safe Thermo-Responsive Gel Electrolytes for Electrochemical Devices,” filed Sep. 26, 2014, which is incorporated by reference herein.

### FIELD

Embodiments of the invention relate, generally, to phase change electrolytes used to improve safety of electrochemical devices, such as lithium batteries.

### BACKGROUND

Polymer gel electrolytes for lithium batteries have been studied since the 1980's. Conventional polymer gel electrolytes for lithium batteries are often composed of a polymer matrix that immobilizes high amount (>80%) of organic carbonate solvents (such as ethylene carbonate, diethyl carbonate) with lithium salts (such as LiPF₆, LiBF₄). Four major types of polymers had been extensively studied as the gel electrolyte matrix for lithium batteries. They are polyethylene oxide (PEO), poly(methyl methacrylate) (PMMA), poly(acrylonitrile)(PAN) and poly(vinylindene fluoride). Copolymers, such as PEO-PDMS, PMMA-PDMS, PVDF-HFP copolymers had also been reported as various formulations of polymer gel electrolytes.

These gel electrolytes were formulated and expected to improve battery safety by immobilizing the flammable liquid carbonate electrolytes used in the lithium batteries. From a battery safety aspect, immobilizing the flammable electrolyte helps to lower vapor pressure of the battery electrolytes and prevent electrolyte leaking Many of the challenges associated with electrolyte leaking have been addressed with the development of special cell packaging, and therefore keeping in gel form to maintain low vapor pressure is a predominant safety requirement for battery electrolytes.

However, conventional polymer electrolytes are in gel form only below its gel temperature, normally less than 80° C. Above the gel temperature, the physical crosslinking formed between polymer matrix and the solvent is destroyed and the polymer matrix is not able to immobilize the flammable organic liquid electrolytes to keep low vapor pressure for lower risk of flammability. Also, with the temperature increase, the ionic conductivities of the conventional gel electrolytes increase exponentially. However, it is dangerous to keep battery electrolyte with high ionic conductivity above a threshold temperature during abnormal cell safety tests, such as nail penetration, overcharge and over-discharge tests.

From a battery safety aspect, it is desirable to shut down or switch “off” the battery when reaching abnormal high temperature with dramatic ionic conductivity decrease of the electrolyte. When batteries temperature returns to normal range, it is desirable that the electrolyte be switched back “on” with normal high ionic conductivities.

### SUMMARY OF THE INVENTION

Through applied effort, ingenuity, and innovation, solutions to improve polymer electrolytes are discussed herein. Some embodiments provide phase change electrolytes for electrochemical devices. The phase change mechanism is based on an “inter-droplet bridging” theory for organohydrogels. “Inter-droplet bridging” is a kind of physical crosslink structure due to the bridging of non-polar nano-droplets by a bipolar gelator with functional end groups that can partition at the interface between non-polar nano-droplet and polar liquid continue phase. By mixing polar/nonpolar material emulsions with a high pressure homogenizer, phase change electrolytes with droplet size smaller than 100 nm can be prepared with following properties: below a gel temperature, the phase change electrolytes stay in liquid state with high ionic conductivity. At this stage, ionic species have free conductive solvent path in the electrolyte. When the phase change electrolyte is heated above a gel temperature, the inter-droplet bridging effect will turn the phase change electrolyte from liquid to gel state, in the meantime, the ionic conductive solvent path is frozen which result in dramatic decrease of ionic conductivity. Ionic conductivity change is reversible between gel state and liquid state. This reversible change of the electrolyte's liquid/gel state and ionic conductivity can be used as a safety mechanism for various electrochemical systems.

### BRIEF DESCRIPTION OF THE DRAWINGS

Having thus described some embodiments in general terms, reference will now be made to the accompanying drawings, which are not necessarily drawn to scale, and wherein:

FIG. 1A shows a schematic diagram of an example phase change electrolyte at a temperature below the gel temperature T_{gel} in accordance with some embodiments;

FIG. 1B shows a schematic diagram of the phase change electrolyte at a temperature above the gel temperature T_{gel} in accordance with some embodiments;

FIG. 2 shows a flow chart of an example of a method for preparing an aqueous based phase change electrolyte performed in accordance with some embodiments; and

FIG. 3 shows a flow chart of an example of a method for preparing a non-aqueous based phase change electrolyte performed in accordance with some embodiments.

### DETAILED DESCRIPTION

Embodiments discussed herein provide phase change electrolytes capable of overcoming the problems of conventional polymer gel electrolytes.
1. The phase change electrolyte forms gel above a gel temperature (T_{gel}) with dramatic decrease of ionic conductivity.
2. The change of liquid state (below T_{gel}) with high ionic conductivity and gel state (above T_{gel}) with low ionic conductivity of the phase change electrolyte is reversible in a manner analogous to an “on/off” switch.

This reversible change of the electrolyte's ionic conductivity can be used as an inherently safe electrolyte for lithium battery. Due to this function of the electrolytes, lithium batteries can be turned “off” during abnormal abuse condition, such as overcharge or over discharge, or shorting to keep the battery safe. After returning to the normal condition, the electrolyte switches to “On” mode with normal ionic conductivity to keep the battery operational. It is expected that the lithium battery safety can be further enhanced by the phase change electrolyte of present invention with other safety mechanism that have been used in place, such as positive temperature circuit (PTC) and battery management system (BMS).

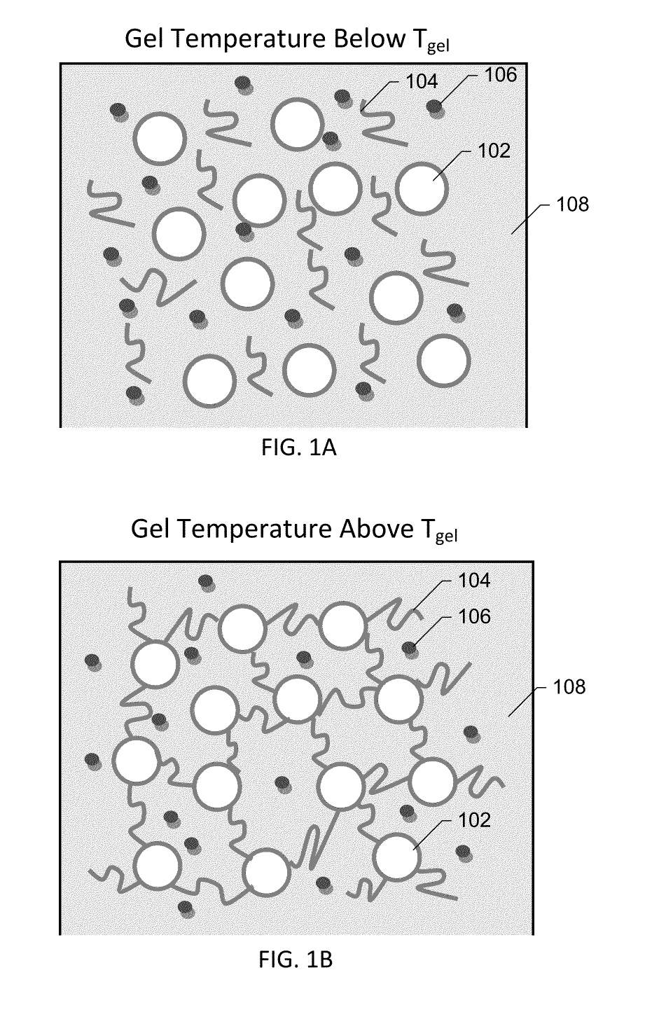

FIG. 1A shows a schematic diagram of an example phase change electrolyte 100 at a temperature below the gel temperature T_{gel}. Phase change electrolyte 100 may include non-polar nano-droplets 102 (or a non-polar material), bipolar gelator 104, and ionic conductive specie 106, and a polar continuous phase 108 (or “polar material”). When the temperature of electrolyte 100 is below the gel temperature T_{gel}, phase change electrolyte 100 stays in liquid state with high ionic conductivity. Ionic species 106 thus have free conductive solvent paths in the electrolyte 100.

The polar material 108 (e.g., polar continuous phase) may include water, alcohols, such as ethyl alcohol, isopropyl alcohol; acrylates, such as methyl acrylate; ionic liquids, such as 1-hexyl-3-methylimidazolium hexafluorophosphate (HMI-HFP), 11-methyl-3-octylimidazolium tetrafluoroborate, 1-butyl-1-methylpyrrolidinium bis(trifluoromethylsulfonyl)imide; and organic carbonates, such as ethylene carbonate, dimethyl carbonate, diethyl carbonate, ethyl methyl carbonate. The non-polar material 102 (e.g., nano-droplets) may include hydrocarbon oils with different molecular with and functional groups, silicone oils, silicone polymers, such as poly(dimethyl siloxane) (PDMS) with different molecular weight and functional groups, and polyolefins with different molecular weight and functional groups. The bipolar gelator 104 may include a polymer surfactant or a non-ionic surfactant, such as polyoxypropylene glycol, glyceryl laurate, polyoxyethylene glycol alkylphenol ethers, poly(ethylene glycol) dimethyl ether, etc. The ionic conductive specie 106 may include a water soluble inorganic salt, such as sodium chloride (NaCl), potassium chloride (KCl), lithium tetrafluoroborate (LiBF4), Lithium hexafluorophosphate, Lithium bis(oxalate)borate (LiBOB), lithium imide salts BETI salts, etc.

FIG. 1B shows a schematic diagram of phase change electrolyte 100 at a temperature above the gel temperature T_{gel}. Here, ionic specie 106 are trapped inside the physical crosslinked gel structure due to the bridging of non-polar nano-droplets 102 by bipolar gelator 104 with functional end groups that can partition at the interface between non-polar nano-droplets 102 and the polar continuous phase. As discussed above, the inter-droplet bridging effect will turn the liquid electrolyte to a gel state. Furthermore, the ionic conductive solvent path is frozen which results in dramatic decrease of ionic conductivity for ionic specie 106. In that sense, ionic conductivity change is reversible between non-conductive/low conductive gel state and high conductive liquid state. This reversible change of the electrolyte's liquid/gel state and ionic conductivity can be used as a safety assuring guard for various electrochemical systems.

In various embodiments, phase change electrolyte 100 can be either an oil in water system for aqueous electrochemical system or a non-aqueous system composed of non-polar material droplets dispersed in a polar organic solvents with a bipolar gelator possessing functional end groups. To achieve the unique properties discussed herein, the phase change electrolyte is prepared using a high pressure homogenizer with multiple passes to keep the droplet size in the range of 10 to 100 nm.

Phase change electrolyte 100 may include an “on/off” property by being capable of transitioning from an “on” state of higher conductivity liquid electrolyte to an “off” state of gel electrolyte with dramatic decrease of ionic conductivity when the electrolyte system is heated above a gel temperature. Therefore, unlike conventional physical cross-linked gel electrolyte systems which form lower conductive gel upon cooling and melting to liquid with higher conductivities upon heating, phase change electrolyte 100 shows a reverse phase transition upon temperature change.

Ionic conductivity transition of this phase change electrolyte 100 is thermo-response and reversible between gel state and liquid. This reversible change of the electrolyte's ionic conductivity can be used as a safety assuring guard for the electrochemical system. For example, the phase change electrolyte 100 can be used to in rechargeable lithium battery to enhance the batteries over-charge and shorting safety. For example, the phase change electrolyte 100 may be disposed between an anode and a cathode of a battery cell.

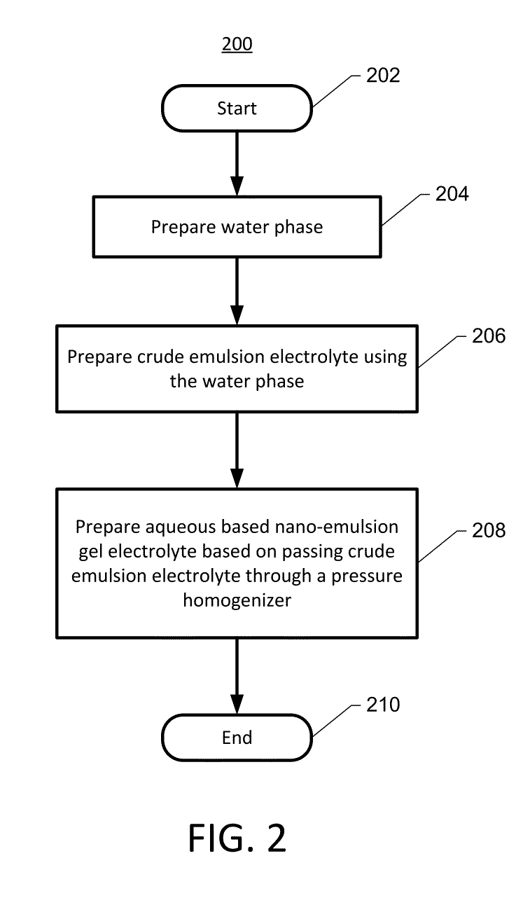

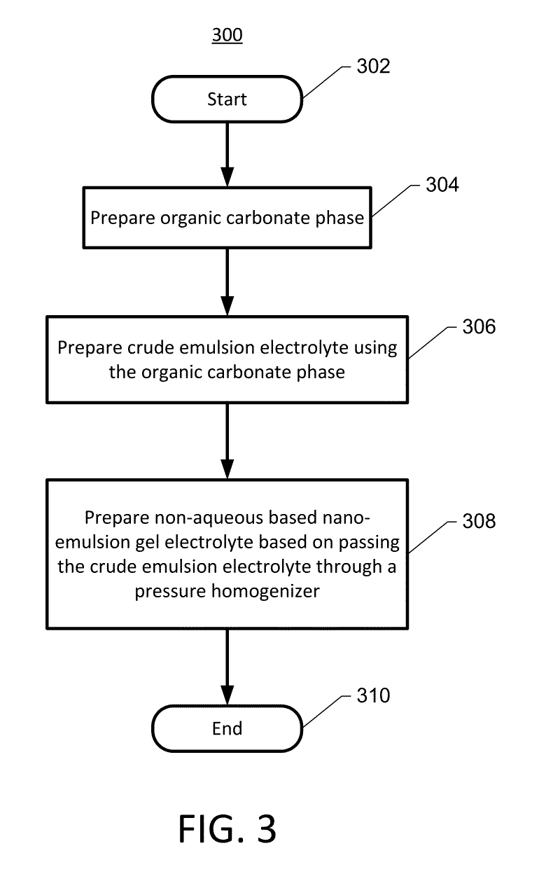

FIGS. 2 and 3 show flow charts of example methods 200 and 300 for preparing a phase change electrolyte. Creating the phase change electrolyte may include preparing a polar material, which may be a water phase or an organic carbonate phase. As such, the phase change electrolyte 100 can be used for either aqueous or non-aqueous electrolyte systems. FIG. 2 shows a flow chart of an example of a method 200 for preparing an aqueous based phase change electrolyte performed in accordance with some embodiments. Method 200 may begin at 202 and proceed to 204, where a water phase polar material base may be prepared. For example, water may be mixed with a surfactant (such as sodium dodecyl sulfate), a bipolar organic gelator (such as poly(ethylene glycol) di-acrylate) and an inorganic salt (such as potassium chloride), with proper amount for each component.

At 206, a crude emulsion electrolyte may be prepared using the water phase. For example, a non-polar polymer (e.g., poly(dimethyl siloxane)) may be mixed with the water phase prepared at 204.

At 208, the phase change electrolyte may be prepared based on passing the crude emulsion electrolyte through a pressure homogenizer. For example, the crude emulsion electrolyte formulation prepared at 206 may be fed through the pressure homogenizer, such as an Emulsiflex-C3 homogenizer manufactured by Avestin, Inc. In some embodiments, pressure can be set at or near 15 Kpsi. The samples may be to be cooled to 5° C. between passes through the pressure homogenizer, with a total of 15˜20 passes until no significant change of average droplet size is achieved with additional passes. The droplet size may be kept in the range of 10 to 100 nm.

An exemplary formulation of a water based phase change electrolyte is 1M KCl, 200 mM sodium dodecyl sulfate (SDS), 30% vol of poly(ethylene glycol) diacrylate (PEGDA) and 33% of poly(dimethyl siloxane) (PDMS) water emulsion. Method 200 may then proceed to 210 and end.

FIG. 3 shows a flow chart of an example of a method 300 for preparing a non-aqueous based phase change electrolyte performed in accordance with some embodiments. Method 300 may begin at 302 and proceed to 304, where an organic carbonate phase polar material base may be prepared. For example, ethylene carbonate and diethyl carbonate may be mixed with a bipolar organic gelator (such as poly(ethylene glycol) dimethyl ether) and an inorganic lithium salt (such as LiBF₄), with proper amounts for each component.

At 306, a crude emulsion electrolyte may be prepared using the organic carbonate phase. For example, non-polar polymer (such as PDMS or PDMS-PEO copolymer) may be mixed with the organic carbonate phase prepared at 304 with proper amount for each phase.

At 308, a phase change electrolyte may be prepared based on passing the crude emulsion electrolyte through a pressure homogenizer. For example, the crude emulsion electrolyte formulation prepared at 306 may be fed through the pressure homogenizer, with the pressure set at or near 15 Kpsi. The samples may be cooled to 5° C. between the passes through the pressure homogenizer, with a total of 15˜20 passes until no significant change of average droplet size is achieved with additional passes. The droplet size may be kept in the range of 10 to 100 nm.

An exemplary formulation of an organic carbonate based phase change electrolyte is 1M LiBF₄, 30% vol of poly(ethylene glycol) dimethyl ether (PEGDME) and 33% of poly(dimethyl siloxane) (PDMS) in a 3:7 by weight mixture of ethylene carbonate and diethyl carbonate. Method 300 may then proceed to 310 and end.

Many modifications and other embodiments will come to mind to one skilled in the art to which these embodiments pertain having the benefit of the teachings presented in the foregoing descriptions and the associated drawings. Therefore, it is to be understood that embodiments and implementations are not to be limited to the specific example embodiments disclosed and that modifications and other embodiments are intended to be included within the scope of the invention.

That which is claimed:

1. An electrochemical device, comprising:
a phase change electrolyte formulated to switchably change from a low ionic conductive gel state to a high ionic conductive liquid state in response to changes of temperature, wherein:
above a gel temperature, the electrolyte forms the low ionic conductive gel state with a first ionic conductivity; and
below the gel temperature, the electrolyte forms the high ionic conductive liquid state having a second ionic conductivity, the first ionic conductivity being less than the second ionic conductivity.

2. The electrochemical device of claim 1, wherein the phase change electrolyte includes of a non-polar material, a bipolar gelator, an ionic conductive specie, and a polar material.

3. The electrochemical device of claim 2, wherein when at below the gel temperature, the phase change electrolyte is in the high ionic conductive liquid state with the polar material providing ionic conductive paths for the ionic conductive specie.

4. The electrochemical device of claim 2, wherein when at above the gel temperature, the phase change electrolyte is in the low ionic conductive gel state such that the bipolar gelator cross-links the non-polar material and freeze ionic conductive paths for the ionic conductive specie in the polar material.

5. The phase change electrolyte of claim 2, wherein the polar material includes water, alcohols, ionic liquids, acrylates, and organic carbonates.

6. The phase change electrolyte of claim 2, wherein non-polar material includes hydrocarbon oils, silicone oils, silicone polymers, and polyolefins.

7. The phase change electrolyte of claim 2, wherein the bipolar gelator includes at least one of a polymer surfactant or a non-ionic surfactant.

8. The phase change electrolyte of claim 2, wherein the ionic conductive specie include water soluble lithium salts, potassium salts and sodium salts.

9. A method of manufacturing a phase change electrolyte for an electrochemical device, comprising:
preparing a polar material base by mixing a bipolar gelator, an ionic conductive specie, and a polar material;
creating a crude emulsion electrolyte by mixing the polar material base and a non-polar material; and
creating (nanometer sized) the phase change electrolyte by passing the crude emulsion electrolyte through a high pressure homogenizer, wherein:
the phase change electrolyte is configured to switchably change from a low ionic conductivity gel state to a high ionic conductivity liquid state in response to changes in temperature;
above a gel temperature, the electrolyte forms the low ionic conductivity gel state with a first ionic conductivity; and
below the gel temperature, the electrolyte forms the high ionic conductivity liquid state having a second ionic conductivity, the first ionic conductivity being less than the second ionic conductivity.

10. The method of claim 9, wherein creating the phase change electrolyte includes mixing a non-polar material, a bipolar gelator, an ionic conductive specie, and a polar material.

11. The method of claim 10, wherein when at below the gel temperature, the phase change electrolyte is in the high ionic conductive liquid state with the polar material base providing ionic conductive paths for the ionic conductive specie.

12. The method of claim 10, wherein when at above the gel temperature, the phase change electrolyte is in the low ionic conductive gel state such that the bipolar gelator cross-links the non-polar material and freeze ionic conductive paths for the ionic conductive specie in the polar material.

13. The method of claim 9, wherein creating phase change electrolyte further includes cooling the crude emulsion electrolyte after passing the crude emulsion electrolyte through the pressure homogenizer.

14. The method of claim 9, wherein preparing the polar material base includes mixing water with a bipolar gelator, and a water soluble salt.

15. The method of claim 9, wherein preparing the polar material base includes mixing an organic polar material, such as an organic carbonate compound, with a bipolar gelator, a water soluble salt.

16. The method of claim 9, wherein creating the non-aqueous based nano-emulsion gel electrolyte further includes, for a predetermined number of cycles, passing the crude emulsion electrolyte through the pressure homogenizer and then cooling the crude emulsion electrolyte.

17. The method of claim 9, wherein creating the crude emulsion electrolyte includes mixing a non-polar polymer with the polar material base composed of a bipolar gelator, an ionic conductive specie, and a polar material such as an organic carbonate compound.
